(19) United States
(12) Patent Application Publication
(10) Pub. No.: US 2025/0137283 A1
(43) Pub. Date: May 1, 2025

(54) METAL FENCE POST TOPPER WITH LOCKING CLIP

(71) Applicant: Joseph Berto, Shady Cove, OR (US)

(72) Inventor: Joseph Berto, Shady Cove, OR (US)

(21) Appl. No.: 18/494,847

(22) Filed: Oct. 26, 2023

(51) Int. Cl. E04H 17/00; A01K 3/00; E04H 17/10

(52) U.S. Cl. CPC E04H 17/006; A01K 3/005; E04H 17/017; E04H 17/124

(57) ABSTRACT

A topper cap and sleeve for a metal fence post is provided with a housing and an internal locking clip to secure the topper to the metal fence post and an optional external hot wire provision for attaching an electric fence. The topper can be made of plastic and is designed, for example, to protect animals from encountering the dangerous exposed top of the metal fence post.

### FIELD OF THE DISCLOSURE

The present invention is directed to a metal fence post topper for metal fence posts, T posts, Y posts, or star posts, for example, a plastic topper for metal fence posts, T posts, Y posts, or star posts. The topper has an internal locking clip that is secured to the metal fence post to help prevent the topper from being dislodged. The topper can also have an external electrified tape or wire provision to provide additional security and deterrence.

### BACKGROUND

Metal fence posts, which can include steel fence posts, for example, T posts (or T-Posts) that are common in the United States, Y posts and star posts that are more common in Australia and New Zealand, are commonly used in farming and ranching operations to construct fences and other structures. The typical metal fence post, for example, has a blunt top with many sharp edges that can be dangerous to humans and animals if contact is made. In particular, animals kept in confinement can be injured by the sharp points of the metal fence posts. Various devices have been proposed to cover or otherwise protect the sharp points of metal fence posts. However, these devices, though widely accepted and/or have various drawbacks. For example, they depend solely on friction to prevent their removal and are difficult to install. Currently, there are no locking toppers available to prevent their unintentional removal, exposing animals to the sharp top of a metal fence post or causing the electrified portion to short out.

### SUMMARY

In consideration of the above issues, it would be desirable to have a metal fence post topper that provides a safe and secure barrier between animals and the exposed top of the metal fence post. The internal locking clip helps prevent the topper from being dislodged, and the hot wire provision allows for an electrical deterrent to be securely attached.

The present invention relates to a protective plastic topper for metal fence posts, and more specifically, to a plastic topper having an internal locking clip that is secured to the metal fence post to help prevent the topper from being dislodged, the clip capable of being secured regardless of the trimmed length of the metal post, and an external hot wire provision to provide additional security and deterrence.

A topper is disclosed that is configured to be received on a metal fence post. The topper includes a housing configured to fit over the top of the metal fence post. The topper further includes an internal locking clip secured to the metal fence post to prevent the topper from being dislodged, the clip capable of being secured regardless of the trimmed length of the metal post. In addition, an external hot wire provision to provide an additional deterrent to animals that may attempt to dislodge said topper from the metal fence post.

A method is disclosed for attaching a topper on a metal fence post, the method comprising: placing an internal locking clip onto the metal fence post; attaching a housing to the internal locking clip; and securing the housing over a top of the metal fence post with the internal locking clip.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention.

FIG. 1 is a perspective view of a topper, according to the present disclosure, attached to a metal fence post in accordance with an embodiment.

FIG. 2 is another perspective view of a topper showing a slidable port on a back side of the housing and locking clip boss in accordance with an embodiment.

FIG. 3 is an end view of the topper showing the slidable port on the back slide of the housing and locking clip boss in accordance with an embodiment.

FIG. 4 is a perspective view of the topper attached to a metal fence post and a transparent view of the internal locking clip in a lower position in accordance with an embodiment.

FIG. 5 is another perspective view of the topper attached to a metal fence post and a transparent view of the internal locking clip in accordance with an embodiment.

FIG. 6 is a side view of the topper illustrating an external hot wire provision attached to a metal fence post and the internal locking clip in a lower position in accordance with an embodiment.

FIG. 7 is a transparent side view of the topper illustrating the internal locking clip attached to a metal fence post in the lower position.

FIG. 8 is a side view of the topper illustrating an external hot wire provision attached to a metal fence post and the internal clip in an upper position in accordance with an embodiment.

FIG. 9 is a transparent side view of the topper illustrating the internal locking clip attached to a metal fence post in the upper position.

FIG. 10 is a top view of the internal locking clip in accordance with an embodiment.

FIG. 11 is a top view of the internal locking clip attached to a metal fence post in accordance with an embodiment.

FIG. 12 is a transparent top view of the internal locking clip attached to a metal fence post in accordance with an embodiment.

FIG. 13 is an illustration of a topper with a hot wire clip and an internal locking clip in accordance with an embodiment.

FIG. 14 is a perspective view of the internal locking clip in accordance with an embodiment.

FIG. 15 is a perspective view of the locking clip in the upper position above the T posts nubs.

FIG. 16 is another perspective view of the locking clip in the upper position in accordance with an embodiment.

FIG. 17 is a front view of the locking clip in the upper position.

FIG. 18 is a perspective view of the locking clip in the lower position between the T post nubs.

FIG. 19 is another perspective view of the locking clip in the lower position.

FIG. 20 is a front view of the locking clip in the lower position between the T post nubs.

FIG. 21 is a back view of the locking clip showing the mounting boss.

FIG. 22 is a transparent side view of an alternative embodiment of the topper in which the topper does not include a top side.

FIG. 23 is a perspective view of a topper in accordance with another embodiment attached to a metal fence post.

FIG. 24 is another perspective view of the topper in accordance with another embodiment attached to the metal fence post.

FIG. 25 is a side view of the topper in accordance with an embodiment.

FIG. 26 is a side view of the topper illustrating an internal locking clip and an external hot wire provision.

FIG. 27 is a top view of the internal locking clip attached to a metal fence post.

FIG. 28 is a side view of the internal locking clip attached to a metal fence post.

FIG. 29 is a side view of another embodiment of a topper with an external locking clip attached to a metal fence post.

FIG. 30 is a partial cut away view of the topper attached to a metal fence post of FIG. 29.

FIG. 31 is a perspective view of a further embodiment with multiple hotwire mounting clips of a topper attached to a metal fence post.

FIG. 32 is a perspective view of an alternative embodiment of a topper without the hotwire clip installed.

FIG. 33 is another perspective view of the topper as shown in FIG. 32.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

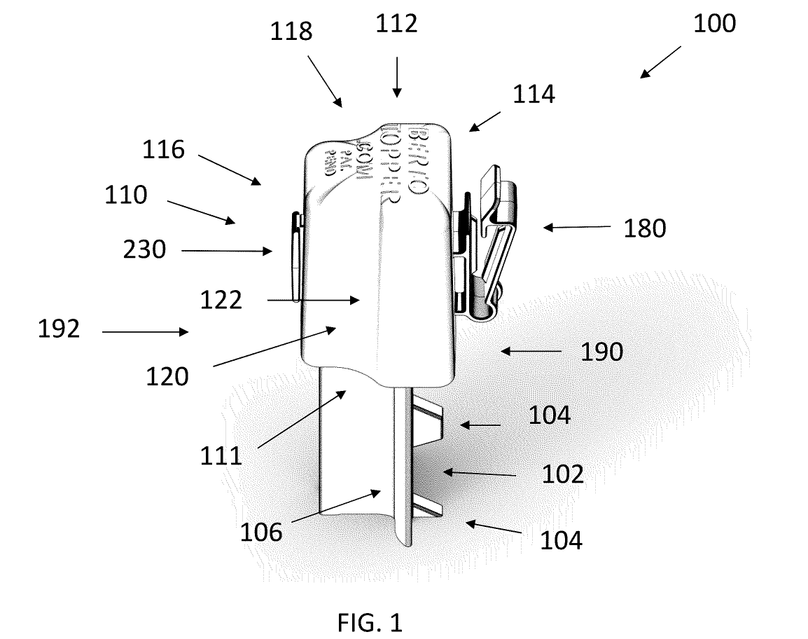

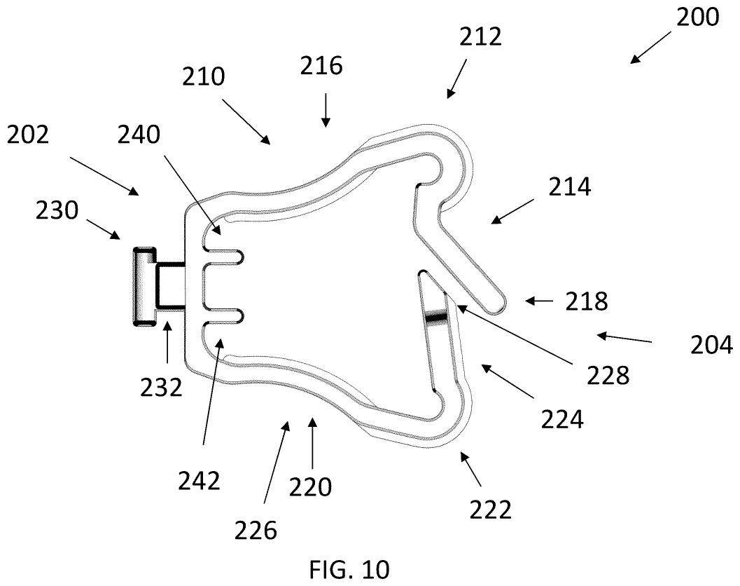

FIG. 1 is a perspective view of a topper (or topper cap) 100 according to an embodiment attached to a metal fence post 102. As shown in FIG. 1, the topper 100 includes a housing 110, an optional external hot wire provision 180, and an internal locking clip (FIG. 10) 200. The housing 110 includes a top side 112, an opening 111 opposite the top side 112 of the housing 110, and a plurality of sides 114, 116, 118, 120. The plurality of sides 114, 116, 118, 120 of the housing 110 can include a front side 114, a back side 116, a right side 118, and a left side 120. As shown in FIG. 1, each of the right and left sides 118, 120 can include a contour that follows the shape of the metal fence post 102 such that the right and left sides 118, 120 extend outward to accommodate a portion 106 of the metal fence post 102. In an embodiment, the housing 110 and the plurality of sides 114, 116, 118, 120 can be shaped or formed in the shape of the metal fence post, for example, in T shape or Y shape with an additional top surface area to help prevent injuries from impalement. For example, the right and left sides 128, 120, can include, for example, a ridge (or curved edge) 122 configured to the different shapes of the metal fence post 102. The ridge 122 can be configured to mirror the shape of the T post from a top of the top to the vertical portion of the T post.

As shown in FIG. 1, the metal fence post 102 also includes a plurality of nubs (or studs) 104. The metal fence post 102 can include an anchor plate that helps keep the metal fence post secured under the ground The plurality of studs 104 are evenly spaced down the length of the metal fence post 102 that range in height, for example, from 5 feet to 10 feet depending on the need of the user. In accordance with an embodiment, the optional external hot wire provision 180 can be arranged on the side of the metal post with the nubs (or studs) 104, which can be referred to as a fence side 190 and the side of the metal post 102 opposite to the nubs (or studs) 104 can be referred to as a non-fence side 192.

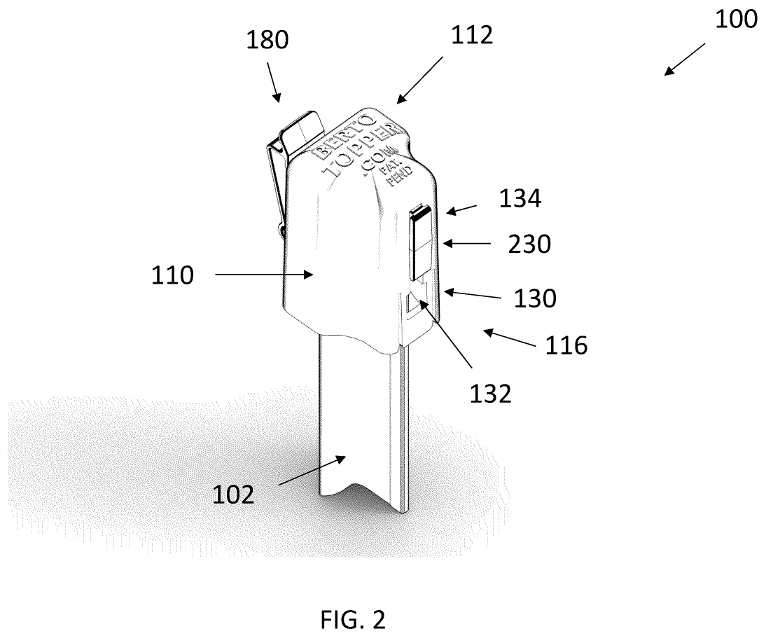

FIG. 2 is another perspective view of a topper 100 showing the back slidable the mount port 130 on the back side 116 of the housing 110 and the locking clip boss 230 in accordance with an embodiment. As shown in FIG. 2, the topper 100 also includes a slidable port 130 on the back side 116 of the housing 110 that includes a receiver 132 and a slot 134 that configured to receive a locking clip boss (or mounting boss) 230 on the internal locking clip 200. The receiver 132 is configured to receive the locking clip boss 230 on a closed end of the internal locking clip 200 and the locking clip boss 230 is configured to slide within the slot 134 on the back side 116 of the housing 110. The locking clip boss 230 is configured to lock the topper 100 into place on the metal post 102.

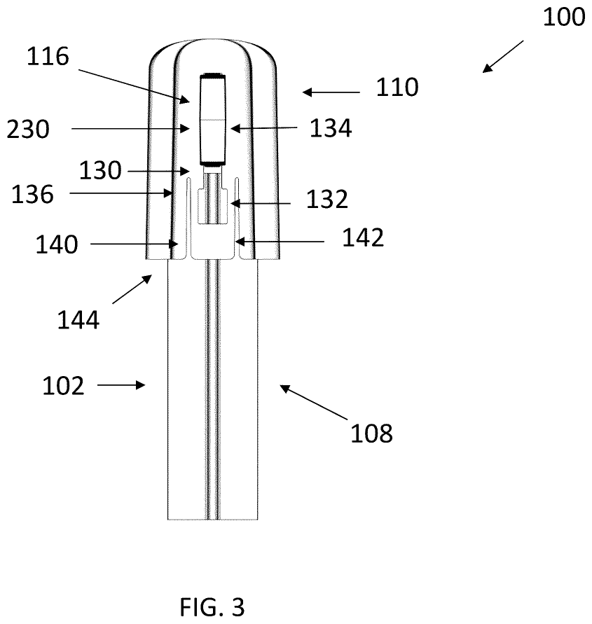

FIG. 3 is an end view of the topper 100 showing the slidable port 130 on the back side 116 of the housing 110 and the locking clip boss 230 in accordance with an embodiment. As shown in FIG. 3, the topper 100 includes the housing 110 having the slidable port 130 on the back side 116 of the housing 110. The slidable port 130 includes the receiver 132 on the lower portion of the slot 134. The receiver 132 preferably has a rectangular shape that is configured to receive the locking clip boss 230 on the closed end 202 (FIG. 10) of the internal locking clip 200. The closed end 202 is on an opposite end of an open end 204 of the internal locking clip 200 that is configured to wrap around the metal fence post 102 and to arranged between a pair of locking nubs (or studs) 105 of the plurality of nubs (or studs) 104 of the metal fence post 102 as disclosed herein.

As shown in FIG. 3, the back side 116 of the housing 110 also includes a pair of slots 140, 142 on a lower portion of the back side 116 of the housing 110. The pair of slots 140, 142 is configured to allow the lower portion of the back side 116 of the housing 110 to be flexible, i.e., bend outward and return after receiving the locking clip boss 230 during the attachment of the housing 110 after the internal locking clip 200 that has been locked or placed onto the metal post 102 as described herein. In accordance with an embodiment, the pair of slots 140, 142 extend from a lower edge 144 of the housing upward to above an upper edge 136 of the receiver 132 of the slidable port 130.

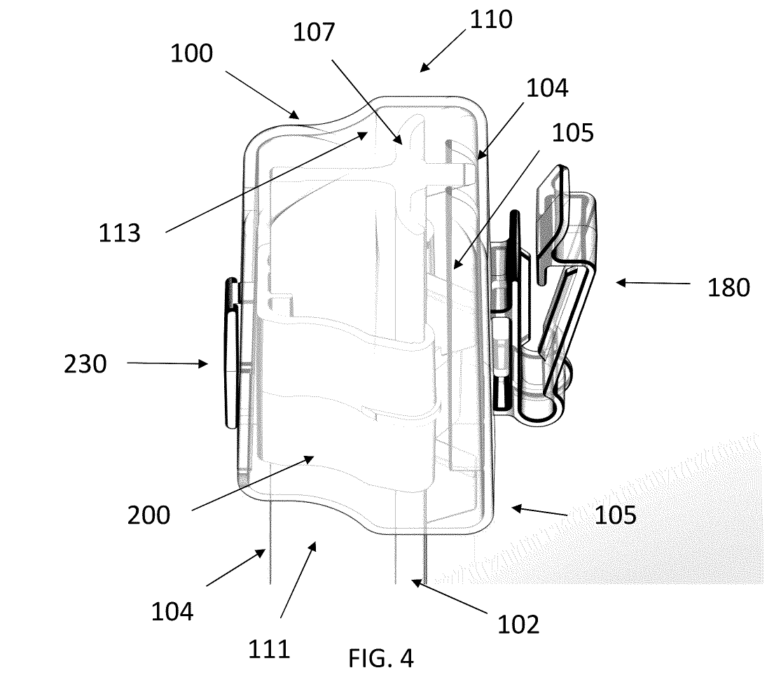

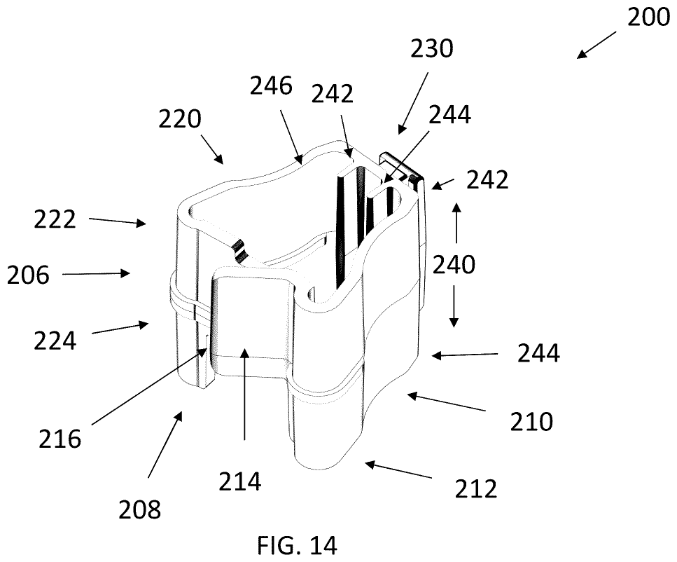

FIG. 4 is a perspective view of the topper 100 attached to a metal fence post 102 and a transparent view of the internal locking clip 200 in a lower position (i.e., the locking portion 206 (FIG. 14) of the internal clip 200 is arranged below the non-locking portion 208 (FIG. 14) of the internal locking clip 200). As shown in FIG. 4, the locking portion 206 of the internal locking clip 200 is arranged between a pair of locking nubs (or studs) 105 of the plurality of nubs (or studs) 104 of the metal post 102). The pair of locking nubs (or studs) 105 are selected from the plurality of nubs 104 on the metal post 102 such that that internal locking clip 200 can be securely fixed to the metal post 102 and the internal locking clip 200 will not, for example, slide off an upper end 107 of the metal post 102. In addition, the internal locking clip 200 is a reversible clip such that upon installation of the topper 100 onto the metal post, an inner portion 113 of the housing 110 of the topper 100 can be in contact with the upper end 107 of the metal post 102, rather than the inner portion 113 of the housing 110 coming into contact with the non-locking portion 208 of the internal locking clip 200.

As shown in FIG. 4, the internal locking clip 200 is secured to the metal fence post 102 between a pair of locking nubs 105 and the housing 110 of the topper 100 is placed on the locking clip boss 230 of the internal locking clip 200 by placing the receiver 132 of the slidable port 130 over the locking clip boss 230 and then sliding the locking clip boss 230 upward into the slot 134 of the slidable port 130. As the locking clip boss 230 slides upward into the slot 132 of the slidable port 130, the housing 110 of the topper 100 will slide downward onto the upper end 107 of the metal post 102.

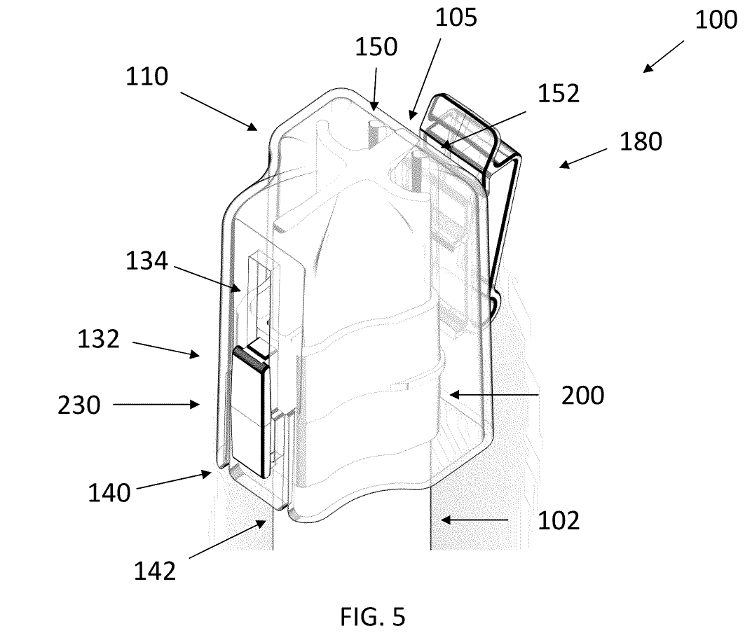

FIG. 5 is another perspective view of the topper 100 attached to a metal fence post 102 and a transparent view of the internal locking clip 200 in accordance with an embodiment. As shown in FIG. 5, the locking clip boss 230 is arranged in the slot 134 of the slidable port 130 in a relatively low position, as the housing 110 of the topper 100 slides downward over the top of the metal T post 102 as a result of the placement of the internal locking clip 200 between a pair of locking nubs 105 on the metal post 102.

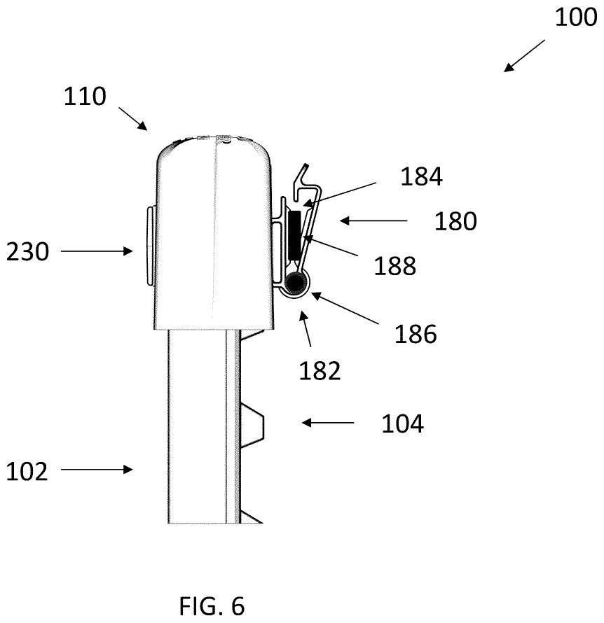

FIG. 6 is a side view of the topper 100 illustrating an external hot wire provision 180 attached to the metal fence post 102 and the internal locking clip 200 in a lower position (i.e., the locking portion 206 of the internal clip 200 is arranged below the non-locking portion 208 of the internal locking clip 200 and between a pair of locking nubs 105 of the metal post 102) in accordance with an embodiment. As shown in FIG. 6, the hot wire provision 180 can include a polyrope (or polywire) 186, or alternatively, a polytape 188 can be arranged above the slot 182 configured to receive the polyrope 186, and between a pair of faces 184 of the hot wire provision 180 that upon locking the hot wire provision with an upper edge portion 186 closes the pair of faces 184 of the hot wire provision around the polytape 188. The polyrope 186 and the polytape 188 can be, for example, electrified.

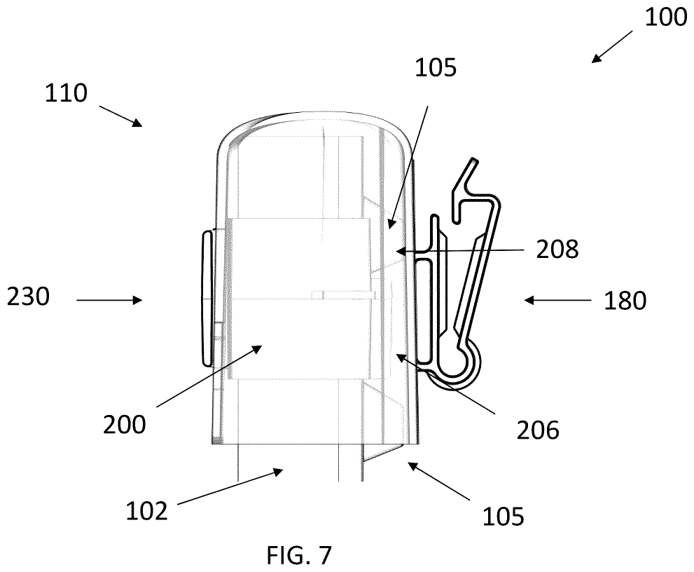

FIG. 7 is a transparent side view of the topper 100 illustrating the internal locking clip 200 attached to a metal fence post 102 in the lower position. As shown in FIG. 7, the locking portion 206 of the internal clip 200 is arranged below the non-locking portion 208 of the internal locking clip 200 and preferably between the first pair of locking nubs 105 of the metal post 102. In the embodiment as shown in FIG. 7, the first pair of locking nubs 105 are arranged on an upper end of the metal post 102.

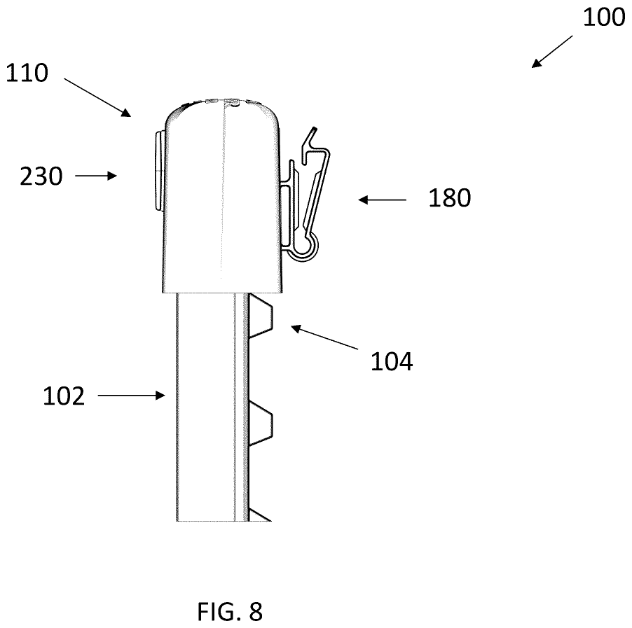

FIG. 8 is a side view of the topper 100 illustrating an external hot wire provision attached 180 to a metal fence post 102 and the internal clip 200 in an upper position (i.e., the locking portion 206 of the internal clip 200 is arranged above the non-locking portion 208 of the internal locking clip 200 and above the nub 104 of the metal post 102) in accordance with an embodiment.

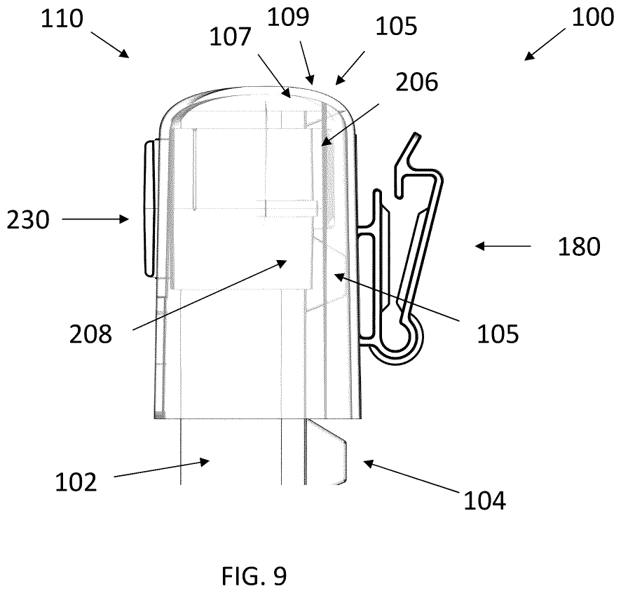

FIG. 9 is a transparent side view of the topper 100 illustrating the internal locking clip 200 attached to the metal fence post 102 in the upper position. As shown in FIG. 9, the locking portion 206 of the internal clip 200 is arranged above the non-locking portion 208 of the internal locking clip 200 and above the nub 104 of the metal post 102 in accordance with an embodiment. In some instances, since the metal post 102 is randomly cut, it is possible that less than a full nub (i.e., a partial nub) 109 may be located on the upper end 107 of the metal post 102, the first pair of locking nubs 105 will be the first pair of nubs 104 on the upper portion of the metal post. However, as long as the less than full nob 109 can prevent the internal locking clip 206 from sliding off of the upper end 107 of the metal post 102, the internal locking clip 200 can be placed in the upper position such that the locking portion 206 of the internal clip 200 is arranged above the non-locking portion 208 such that the non-locking portion 208 of the internal locking clip 200 does not extend above the upper end 107 of the metal post 102. However, it may be desirable, that rather than placing the locking portion 206 of the internal locking clip 206 between the less than full nub 109 and a full nub 105, the internal locking clip 200 may be arranged between the first pair of locking nubs 105, each of the first pair of locking nubs 105 being a full nub 104 and placing the internal locking clip 200 in the lower position as shown in FIGS. 6 and 7.

The topper (or cap) 100 is preferably sized and configured to fit over the top of a metal fence post 102 such that the topper 100 extends over the sharp points of the metal fence post 102. The housing 110, the hot wire provision 180, and the internal clip 200 are preferably made of a durable and flexible plastic material such as polypropylene, polyethylene, polyvinyl chloride (PVC) or nylon. The plastic material of the topper 100 is designed to be flexible and durable enough to withstand animal contact and other forces and can also withstand the elements. For example, in accordance with an embodiment, the top side 112 of the topper 100 can have, for example, an area of about 1000 mm² to 2000 mm², preferably, about 1500 for mm² to 1750 mm², and more preferably, about 1622 mm². The top of the metal fence post 102 can have an area of about 220 mm² to 240 mm², for example, the top of a T post can have an area of about 228 mm². Thus, the topper 100 can provide 500% to 700% increase in surface area to resist impalement of animals, humans, and the like. For example, the housing 110 of the topper 100 has a length of approximately 2 inches to 5 inches, for example, 3 inches to 3½ inches, for example, 3¼ inches. In addition, for the topper 100 to perform the critical safety function of reduced impalement and injuries related thereto, the topper 100 should have enough bulk or size that the topper 100 should not impale humans, animals, and the like.

The topper 100 is preferably sized and configured to fit over the top of a metal fence post 102 such that the topper 100 extends over the sharp points of the metal fence post 102. The topper 100, the internal locking clip 200, and the electrified wire mount 180 and assemblies associated therewith are preferably made of a durable and flexible plastic material such as polypropylene, polyethylene, polyvinyl chloride (PVC) or nylon. The plastic material is designed to be flexible and durable enough to withstand animal contact and other forces and can also withstand the elements.

The locking plastic topper 100 of the present disclosure provides a relatively safe and secure covering for the sharp points of metal fence posts, protecting animals and humans from injury. The locking plastic topper 100 is relatively easy to install and is durable enough to withstand unintended efforts to dislodge it.

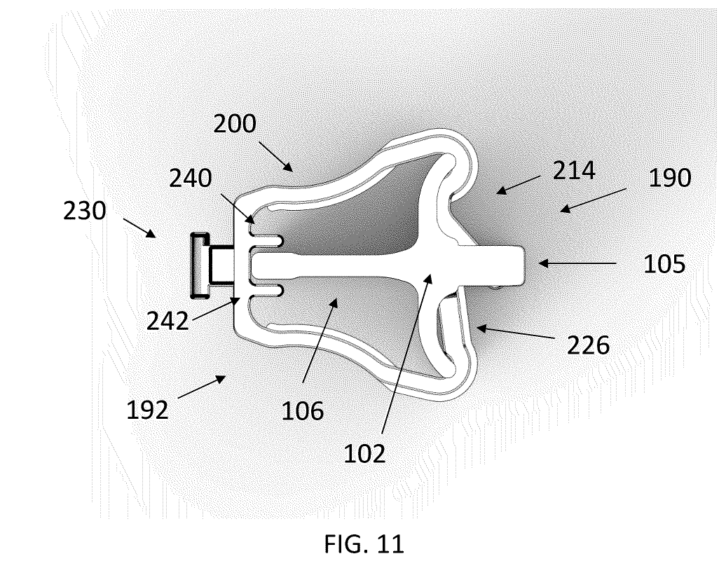

FIG. 10 is a top view of the internal locking clip 200 in accordance with an embodiment. As shown in FIG. 10, the internal locking clip 200 has a pair of curved projections (i.e., fingers) 210, 220 that wrap around or clip to a portion 106 (FIG. 11) of the metal fence post 102. Each of the curved projections (fingers) 210, 220 can include a first concave portion 216, 226 that extend to a convex portion 212, 222. The convex portion 212, 222 is configured to wrap around the metal post 102. The convex portion 212, 222 extends outward to a flange 214 on one end 218, and a clip portion 224 on the other end 228. The flange 214 and the clip portion 224 form the locking portion 206 of the internal clip 200 as disclosed herein. The first concave portions 216, 226 are configured to allow the internal locking clip 200 to flex during installation onto the metal fence post 102.

As shown in FIG. 10, the closed end 202 of the internal clip 200 also includes the locking clip boss 230 that in attached to an extender 232. The extender 232 is configured to fit within the slidable port 130 of the housing 110. For example, the locking clip boss 230 in combination with the extender 232 is configured to slide upward and/or downward from the receiver 132 on the lower portion of the slot 134. On an inner surface of the internal locking clip 200, a pair of guide members 240, 242 are configured to receive a portion of the metal post 102. The open end 204 includes the flange 214 and the clip portion 224.

FIG. 11 is a top view of the internal locking clip 200 attached to a metal fence post 102 in accordance with an embodiment. The internal locking clip 200 extends from the non-fence side 192 (i.e., side opposite of the nubs (or studs) 104) such that the internal locking clip 200 is mounted on the non-fence side 192 of the metal fence post 102. The mounting of the internal locking clip 130 on the non-fence side 192 allows the optional wire provision 180 to be integral 100 on the fence side 190 of the metal fence post 102.

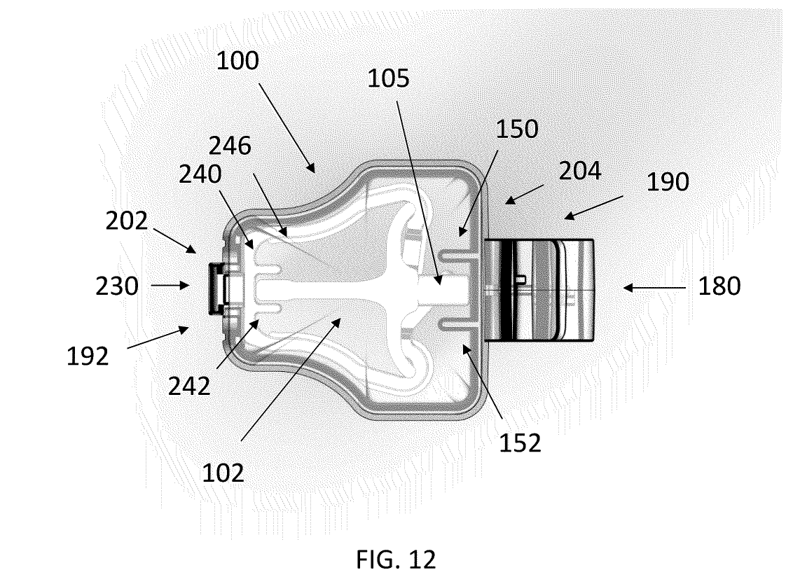

FIG. 12 is a transparent top view of the internal locking clip 200 attached to a metal fence post 102 in accordance with an embodiment. As shown in FIG. 12, the closed end 202 of the internal locking clip 200 is engaged with the non-fence side 192 of the metal post 102 as the open end 204 of the internal clip 200 is arranged on the fence side 190 of the metal post 102. Once the internal clip 200 has been attached to the metal post 102, the receiver 132 portion of the slidable port 130 is placed over the locking clip boss 230 and the housing 110 of the topper 100 is attached to the locking clip boss 230. The topper 100 can then be moved onto a top portion of the metal post 102.

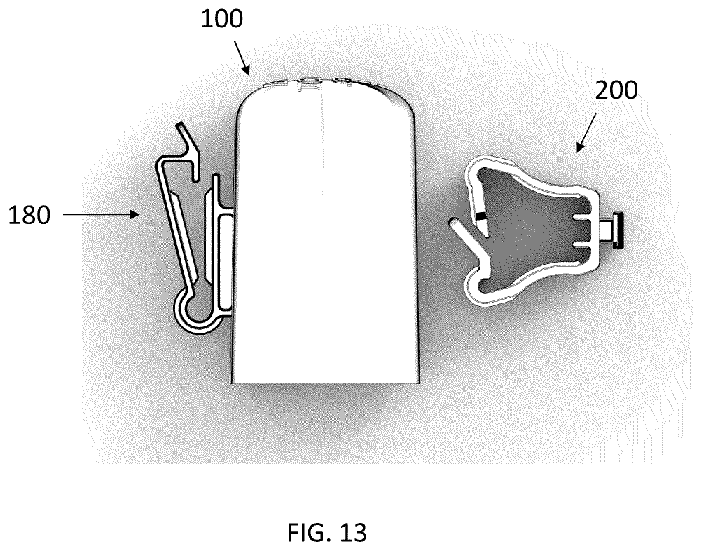

FIG. 13 is an illustration of a topper 100 with a hot wire provision (or hot wire clip 180) and an internal locking clip 200 in accordance with an embodiment. In accordance with an embodiment, each topper 100 can require the internal locking clip 200 to fix the topper 100 onto the metal post 102. As described above, the hot wire provision 180 is optional and not all toppers 100 will include the hot wire provision 180.

FIG. 14 is a perspective view of the internal locking clip 200 in accordance with an embodiment. As shown in FIG. 14, the internal locking clip 200 includes the locking portion 206 and the non-locking portion 208. The locking portion 206 includes the flange 214 and the clip 224. In accordance with an embodiment, the locking clip 200, for example, has a height 240 of approximately 1.5 inches from an upper edge 242 to a lower edge 244 for a 1.33 T post. The 1.33 T post having a weight of approximately 1.33 pounds (lbs.) per foot. For example, in 1.33 T post, the distance between the plurality of nubs 104 is approximately 1 inch. However, the height 240 of the internal locking clip 200 can vary depending on the type of metal post 102. For example, T posts can be 1.25 lbs. to 1.5 lbs. per foot and having a spacing of 1 inch to 2 inches between nubs (or studs) 104. It can be appreciated that the height 240 of the internal locking clip 200 can vary depending on the type of metal post 102 and distance between nubs (or studs) 104.

As shown in FIG. 14, the locking clip boss 230 extends from the upper edge 242 to the lower edge 244 of the internal locking clip 200. In addition, the pair of guide members 240, 242 configured to receive a portion of the metal post 102 on the inner surface 246 of the internal locking clip 200 also extend from the upper edge 242 to the lower edge 244.

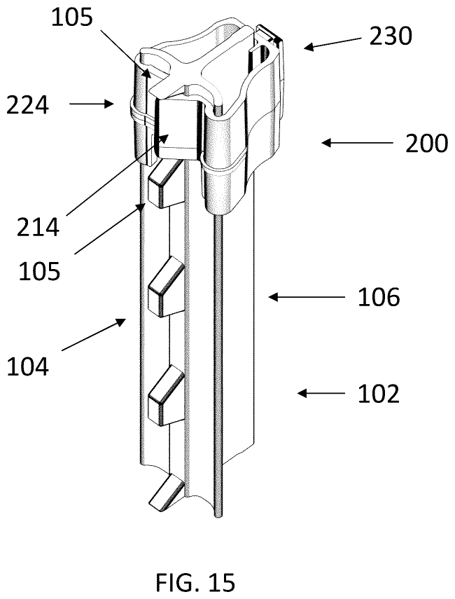

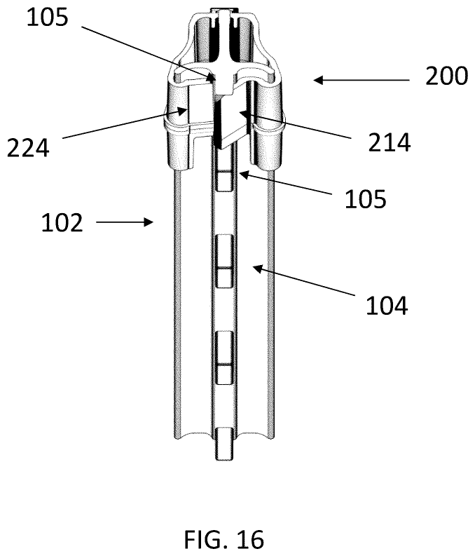

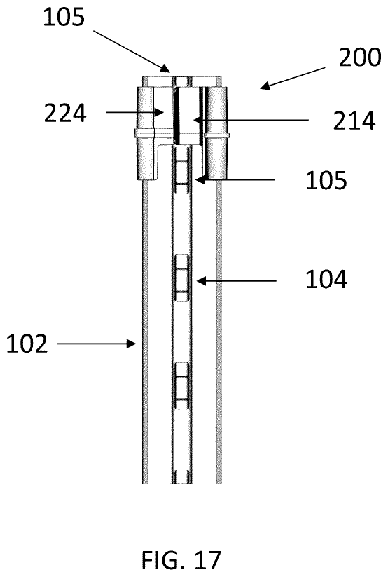

FIGS. 15 and 16 are perspective views of the internal locking clip 200 in the upper position above the T posts nubs. FIG. 17 is a front view of the internal locking clip 200 in the upper position. As shown in FIGS. 15-17, the locking portion 206 of the internal locking clip 200 is arranged above the non-locking portion 208 of the internal locking clip 200 and above the nub (or stud) 104 of the metal post 102.

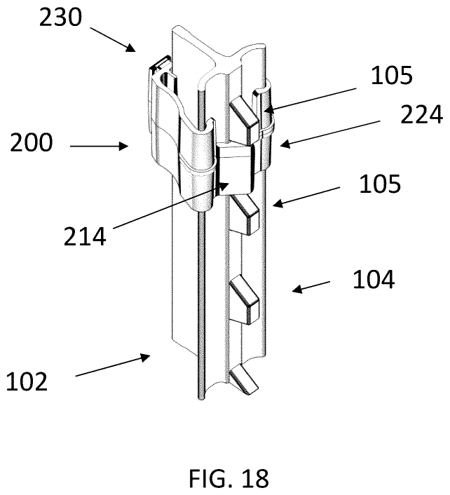

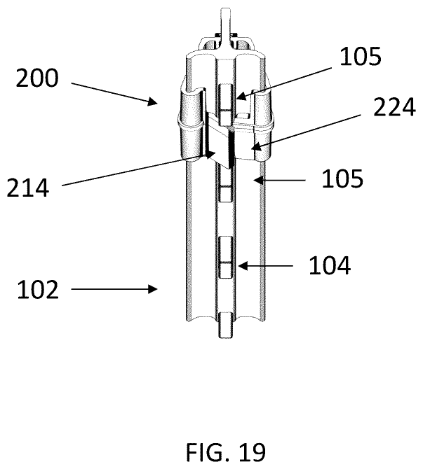

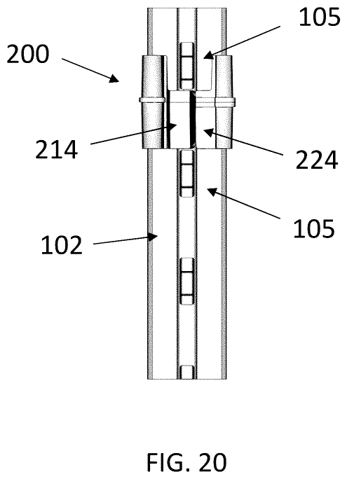

FIGS. 18 and 19 are perspective views of the internal locking clip 200 in the lower position between the T post nubs. FIG. 20 is a front view of the internal locking clip 200 in the lower position between the T post nubs 104. As shown in FIGS. 18-20, the locking portion 206 of the internal clip 200 is arranged below the non-locking portion 208 of the internal locking clip 200 and preferably between a pair of nubs (or studs) 104 of the metal post 102.

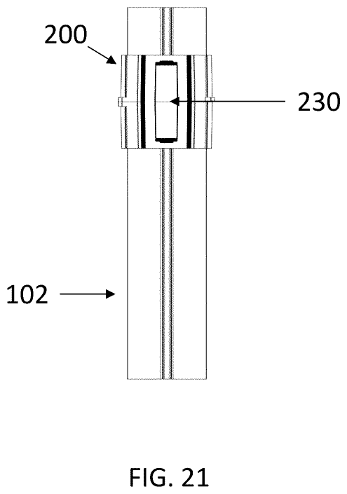

FIG. 21 is a back view of locking clip 200 showing the locking clip boss (or mounting boss) 230. As shown in FIG. 21, the locking clip boss 230 preferably has a rectangular shape extending from an upper edge of the internal locking clip 200 to a lower edge of the internal locking clip 200. The width of the locking clip boss is slightly smaller than the inner diameter of the receiver 132 and larger than the width of the slot 134 of the slidable port 130.

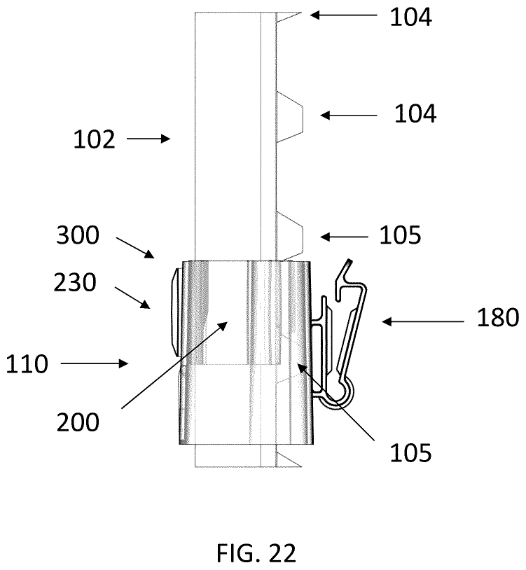

FIG. 22 is a transparent side view of an alternative embodiment of the topper 300 in which the topper 300 does not include a top side. As shown in FIG. 22, the topper 300 does not include the top side 112 as shown, for example, in FIG. 1, which allows the topper 300 to placed anywhere along the metal post 102. The topper 300 is preferably similar to the topper 100 as shown in FIGS. 1-9 with the exception that the topper 300 does not include the top side 112 and can be any length, including the full length of the metal post. For example, in accordance with an embodiment, the topper 300 can be arranged at any position along the metal post 102 by securing in the internal locking clip 200 between a pair of locking nubs (or locking studs) 105 of the plurality of nubs (or studs) 104 and sliding the topper 300 onto the locking clip boss 230 of the internal locking clip 200. In an embodiment, the optional hot wire provision 180 can be configured, for example, to hold a sign, for example, a warning sign indicating “Private Property-No Trespassing”, “No Hunting”, an advertisement, for a company or business, and the like.

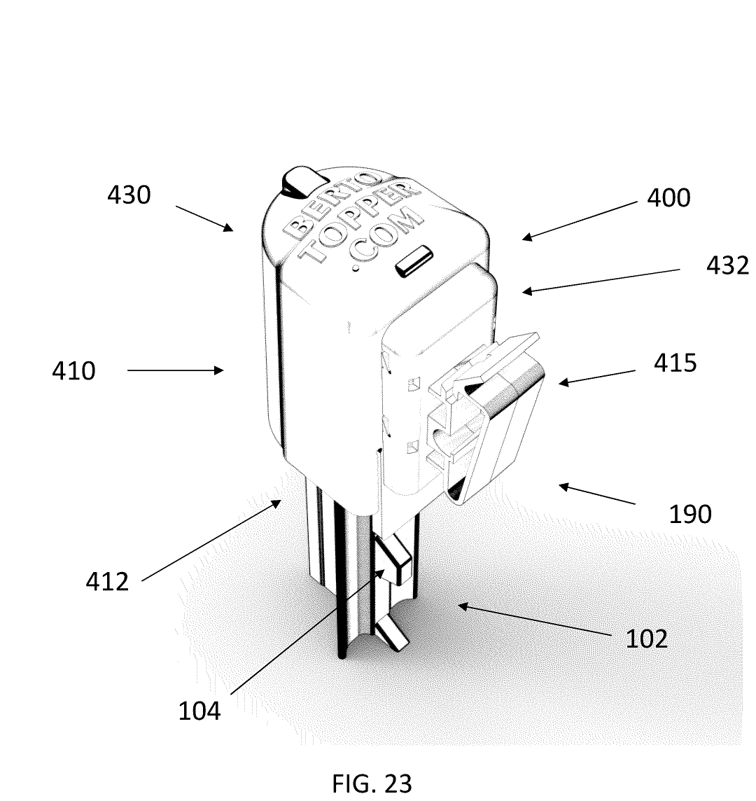

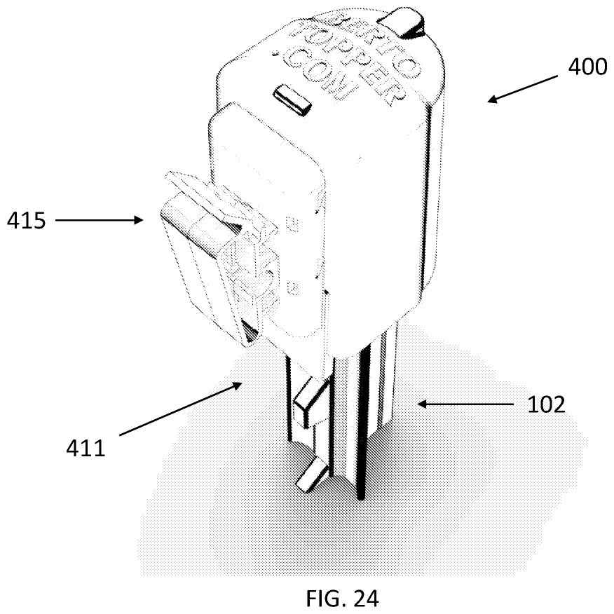

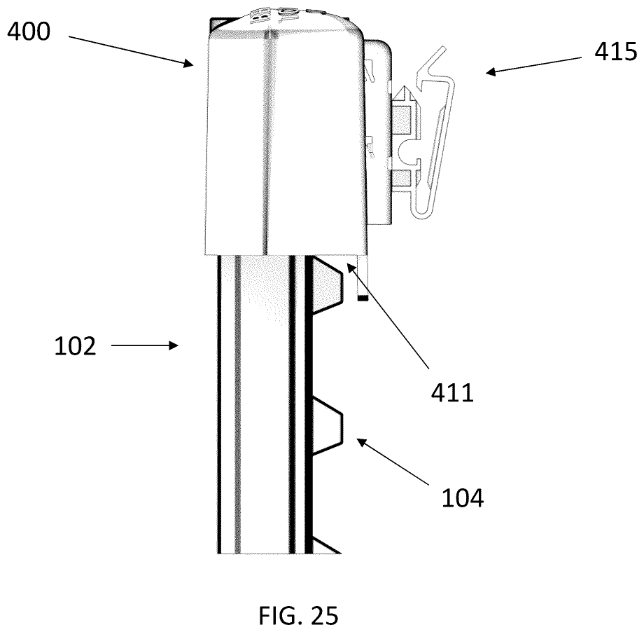

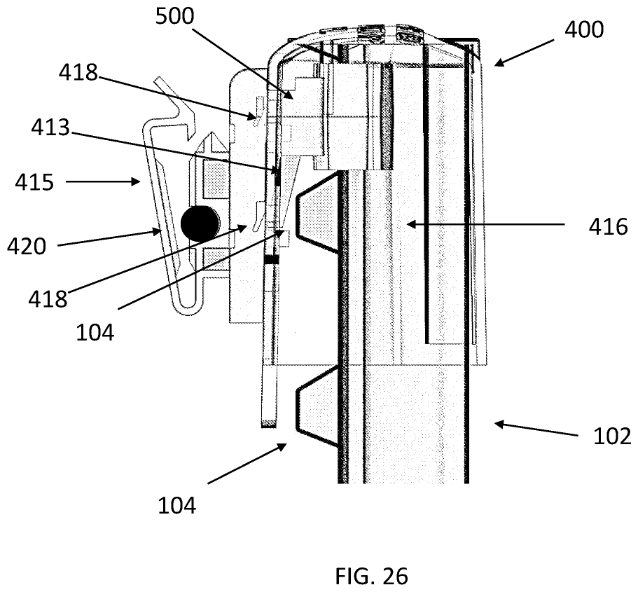

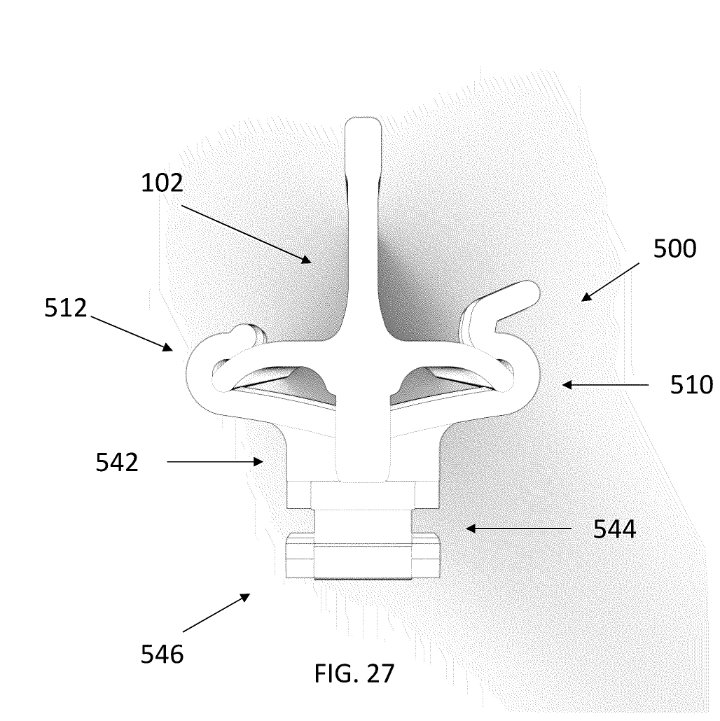

Referring to FIGS. 23-26, another embodiment of a plastic topper 400 includes a housing 410 that is generally square or rectangular in shape with one rounded side 430 and has an open bottom 412 to fit over the top of the metal fence post 102 and is secured by an internal locking clip 500. The locking clip 500 is sized and configured to fit within an inner cavity 416 of the topper 400 and is inserted into and secured by the nubs (or studs) 104 on the fence side 190 of the metal fence post 102. The locking clip 500 is secured to the metal fence post 102 by curved projections (i.e., fingers) 510 (FIG. 27) that wrap around the edges of the metal fence post 102, clamping the topper 400 securely to the metal fence post 102. The locking clip 500 is configured to be secured to the metal fence post 102 such that the plastic topper 400 cannot be removed from the metal fence post 102 without first removing topper 400 from the locking clip 500.

The plastic topper 400 includes a side 432 opposite to the one rounded side 430 with a mounting slot 413 configured to receive the internal locking clip 500 and mounting slots 418 for example, for an electrified wire mount (or hot wire provision) 415. The mounting slots 418 are located on the outside of the topper 400 and can allows a hot wire, or other electrified material 420 such as rope or tape to be secured to the topper 400 via the electrified wire mount 415 to be arranged on the fence side 190 of the metal post 102. The electrified wire mount 415 can also provide an additional layer of security and deterrence to keep animals away from the metal fence post 102 and topper 400.

FIG. 27 is a top view of the internal locking clip 500 attached to a metal fence post 102. As shown in FIG. 27, the internal locking clip 500 includes a pair of curved projections (i.e., fingers) 510 that wrap around the edges of the metal fence post 102. The internal locking clip 500 also includes a body portion 542, a groove 544 configured to fit within the mounting slot 432 of the topper 400 and outer edge 546 that extends though the mounting slot 432 of the topper 400 on the fence side.

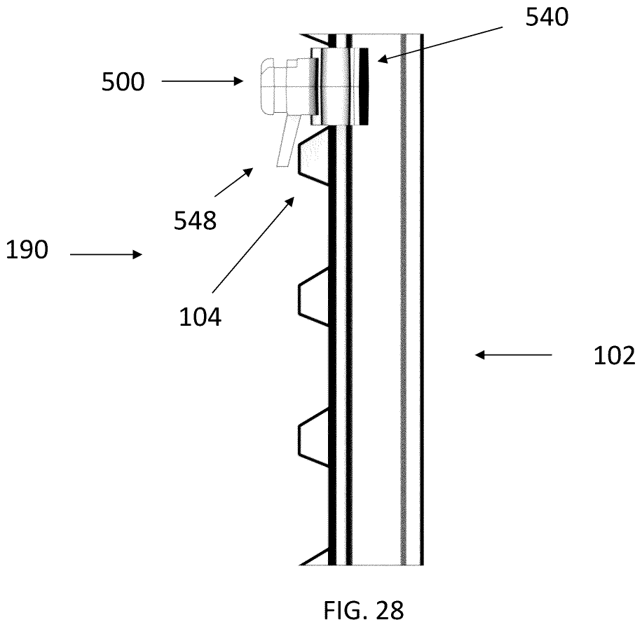

FIG. 28 is a side view of the internal locking clip 500 attached to a metal fence post 102. As shown in FIG. 28, the curved projections (fingers) 510 of the internal locking clip 500 wrap around the metal fence post 102 between one or more notches 104 on the metal fence post 102. The internal locking clip 500 can also include a flap 548 extending downward to assist with securing the internal locking clip 500 to the topper 400 and the corresponding mounting slot 432 on the topper 400. The mounting slot 432 can be a linear slot with a rectangular slot arranged on a lower portion of the linear slot. The mounting slot 432 can be configured to receive the outer edge 546 of the internal locking clip 500. The outer edge 546 of the internal locking clip 500 preferably has a width greater than the linear slot of the mounting slot 432.

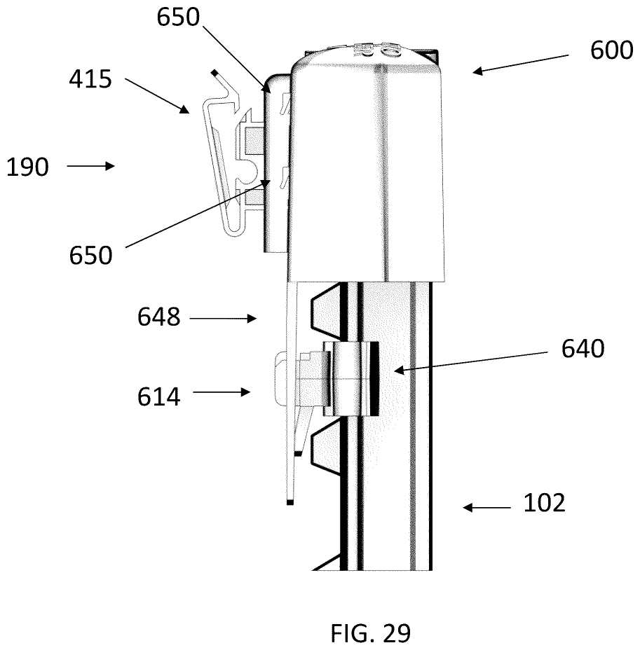

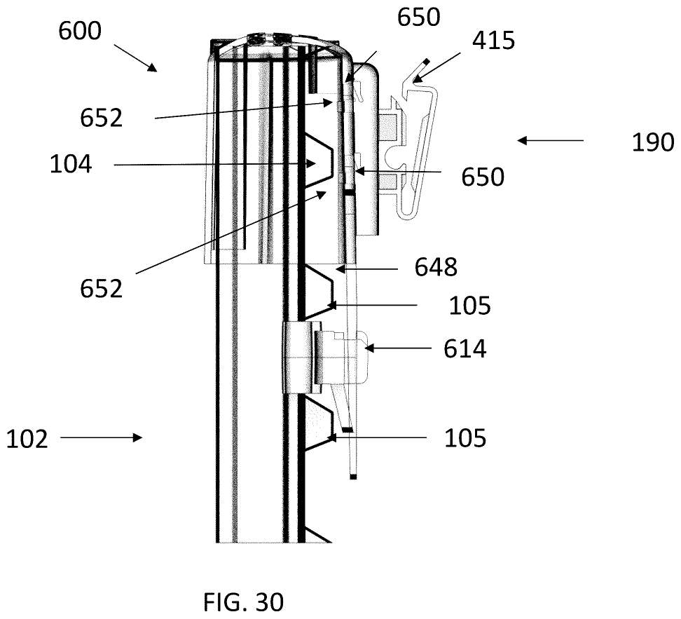

FIGS. 29 and 30 are side views of another embodiment of a plastic topper 600 attached to a metal fence post 102, and a partial cut away view of the plastic topper 600, respectively. As shown in FIGS. 29 and 30, the locking clip 614 is configured to be fixed to the metal post 102 below the topper 600. The plastic topper 600 can be attached to the metal fence post 102 with a locking clip 614 that is attached between the locking nubs (or studs) 105 of the metal post 102 and extends upward to an inner portion of the topper 600 via an extension 648 of the topper 600. The extension 648 includes a pair of grooves 650 that are configured to attach to a pair of clips 652 on the fence side 190 of the topper 600. The locking clip 614 includes curved projections or fingers 640 configured to wrap around the metal fence post 102 between one or more nubs (or studs) 104 on the metal fence post 102. The electrified wire mount (or hot wire provision) 415 as shown is arranged on the fence side 190 of the metal post 102.

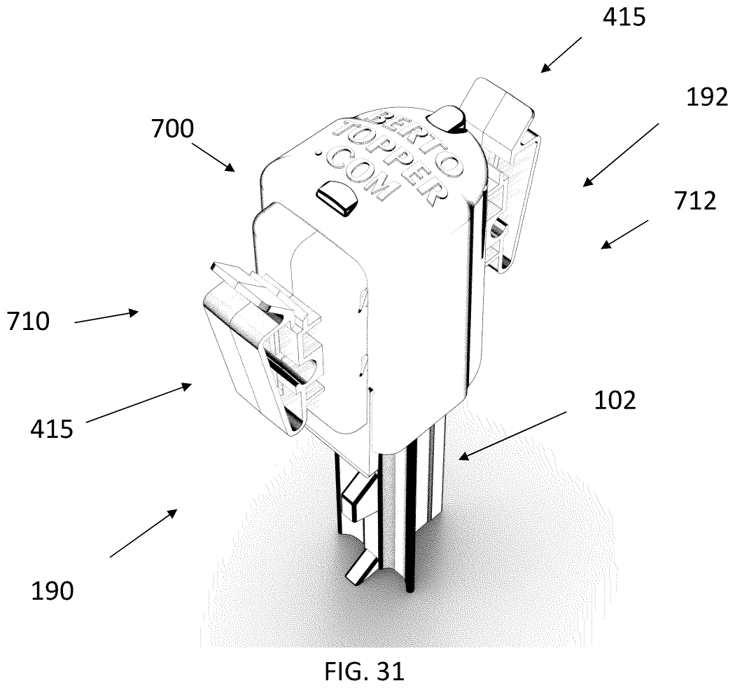

FIG. 31 is a perspective view of a further embodiment of a plastic topper 700 attached to a metal fence post 102. As shown in FIG. 31, the plastic topper 700 can include two or more electrified wire mounts 415. The two or more electrified wire mounts 415 can be arranged, for example, on a front side 710 and a back side 712 of the topper 700 such that the two or more wire mounts 415 can be arranged 180 degrees from one another. Thus, as shown in FIG. 31, the two or more electrified wire mounts 415 can be on both the fence side 190 and non-fence side 192 as described herein. Each of the two or more wire mounts 415 can be configured to receive, for example, a hot wire, or other electrified material such as rope or tape to be secured to the topper 700 via the electrified wire mount 415.

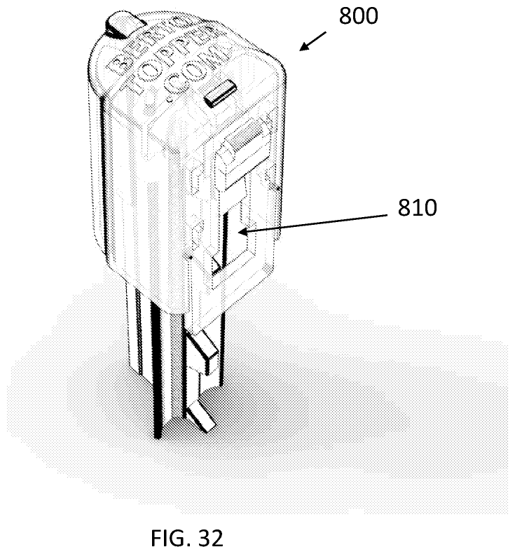

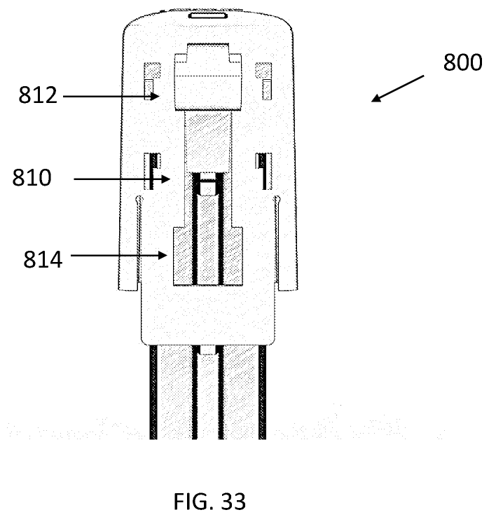

FIGS. 32 and 33 are perspective view on the fence side 190 of an alternative embodiment of a mounting slot 810 for a topper 800 having a generally elongated rectangular shape with a pair of wider ends 812, 814 on each end of the generally rectangular shape of the mounting slot 810 with no hot wire. The mounting slot 810 can be configured to receive, for example, an electrified wire mount 415 (FIG. 23) to be arranged on the fence side 190 of the metal post 102.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention. It is to be understood that the present invention is not limited to the embodiment described above but encompasses any and all embodiments within the scope of the following claims.

What is claimed is:

1. A topper configured to be received on a metal fence post, the topper comprising:
a housing configured to fit over a top of the metal fence post; and
an internal locking clip configured to secure the housing to the metal fence post.

2. The topper according to claim 1, wherein the internal locking clip include a pair of curved projections, each of the pair of curved projections extend to a convex portion configured to wrap around the metal fence post.

3. The topper according to claim 2, wherein the convex portions of the pair of curved projections extends outward to a flange on one end of the internal locking clip and a clip portion on an other end of the internal locking clip, and the each of the pair of curved projections includes a concave portion arranged between the clip portion on the other end of the internal locking clip and the convex portion configured to wrap around the metal fence post, the concave portion configured to allow the internal locking clip to flex during installation onto the metal fence post.

4. The topper according to claim 3, wherein the flange on the one end of the internal locking clip and the clip portion on the other end of the internal locking clip form a locking portion of the internal locking clip.

5. The topper according to claim 4, wherein the internal locking clip includes the locking portion of the internal locking clip and a non-locking portion, and wherein the non-locking portion does not include the flange on the one end of the internal locking clip and the clip portion on the other end of the internal locking clip.

6. The topper according to claim 4, wherein the locking portion of the internal locking clip is configured to wrap around the metal fence post above and/or below a stud of the metal fence post.

7. The topper according to claim 5, wherein the non-locking portion of the internal locking clip is configured to be arranged on the metal fence post adjacent to a stud of the metal fence post.

8. The topper according to claim 1, wherein the housing includes a top, an opening opposite the top of the housing, and a plurality of sides, and wherein the plurality of sides of the housing have contours that follows a shape of the metal fence post.

9. The topper according to claim 1, wherein the housing includes a slidable port on a back side of the housing, the slidable port includes a receiver and a slot configured to receive a locking clip boss on the internal locking clip.

10. The topper according to claim 9, wherein the back side of the housing further includes a pair of grooves, the pair of grooves configured to allow the slidable port to flex upon receiving the locking clip boss on the internal locking clip.

11. The topper according to claim 1, wherein the internal locking clip has a pair of curved projections configured to wrap around or clip to a portion of the metal fence post, and the internal locking clip further incudes an end portion attached to the pair of curved projections, the end portion configured to fit within a slot within the housing.

12. The topper according to claim 10, wherein each of the curved projections include a first concave portion that extends to a convex portion, the convex portion being configured to wrap around the portion of the metal fence post.

13. The topper according to claim 12, wherein the convex portion of each of the curved projections extends outward to a second concave portion having a free end.

14. The topper according to claim 1, wherein the internal locking clip extends from a non-fence side, the non-fence side being a side opposite of a plurality of studs on the metal fence post.

15. The topper according to claim 1, further comprising:
an external hot wire provision to provide an additional deterrent to animals that may attempt to dislodge said topper from the metal fence post, wherein the external hot wire provision is an appendage made of a durable plastic material and configured to be secured to the housing and to hold an electrified wire, rope, or tape, the external hot wire provision configured to be placed on the fence side of the metal fence post or the non-fence side of the metal fence post, the fence side being on a side of a plurality of nubs on the metal fence post, and the non-fence side being on a side opposite of the plurality of nubs on the metal fence post.

16. The topper according to claim 1, wherein the housing and the internal locking clip are made of a durable plastic material that is resistant to abrasion, corrosion, and other environmental factors, and wherein the internal locking clip is configured to fit between nubs of the metal fence post and to securely hold the topper in place on the metal fence post.

17. A method for attaching a topper on a metal fence post, the method comprising:
placing an internal locking clip onto the metal fence post;
attaching a housing to the internal locking clip;
securing the housing over a top of the metal fence post with the internal locking clip.

18. The method according to claim 17, further comprising:
fitting a flange on one end of the internal locking clip and a clip portion on an other end of the internal locking clip on a stud side of the metal fence post, the flange and the clip portion extending from a pair of curved projections of the internal locking clip, the internal locking clip having a first concave portion that extend to a convex portion configured to wrap around the metal fence post.

19. The method according to claim 18, wherein the flange on the one end of the internal locking clip and the clip portion on the other end of the internal locking clip form a locking portion of the internal locking clip, and the internal locking clip includes the locking portion of the internal locking clip and a non-locking portion, and wherein the non-locking portion does not include the flange on the one end of the internal locking clip and the clip portion on the other end of the internal locking clip, and the housing includes a slidable port on a back side of the housing, the slidable port includes a receiver and a slot.

20. The method according to claim 19, further comprising:
wrapping the locking portion of the internal locking clip around the metal fence post above and/or below a stud of the metal fence post;
arranging the non-locking portion of the internal locking clip on the metal fence post adjacent to a stud of the metal fence post;
placing the slidable port of the housing on a locking clip boss on the internal locking clip; and
sliding the housing down onto the top of the metal fence post by moving the locking clip boss within the slot of the slidable port.
